(19) United States
(12) Patent Application Publication
(10) Pub. No.: US 2025/0355823 A1
(43) Pub. Date: Nov. 20, 2025

(54) HIGH SPEED COMMUNICATION FIELD DEVICE PLATFORM

(71) Applicant: ROSEMOUNT INC, Shakopee, MN (US)

(72) Inventors: Jon D STOKES, Chaska, MN (US); Shane R HALE, Eden Prairie, MN (US); Marc BUMGARNER, Rosemount, MN (US); Jason H RUD, Chanhassen, MN (US); Theodore H SCHNAARE, New Prague, MN (US)

(21) Appl. No.: 19/204,996

(22) Filed: May 12, 2025

Related U.S. Application Data
(60) Provisional application No. 63/648,967, filed on May 17, 2024.

(51) Int. Cl. G06F 13/36

(52) U.S. Cl. CPC G06F 13/36; G06F 2213/40

(57) ABSTRACT

A system for creating a virtual field device is provided. The system includes a processor having memory that when executed causes the processor to provide a sensor selection user interface element configured to receive user selection of at least one process sensor providing high-speed, unfiltered measurement data. The processor also provides a processing selection user interface element configured to receive user selection of at least one processing action to perform on the high-speed, unfiltered measurement data to generate a process output. The processor also provides an output selection user interface element configured to receive user selection of at least one remote device to which the process output is communicated. A computer-implemented method of creating a virtual field device is also provided.

### CROSS-REFERENCE TO RELATED APPLICATIONS

The present application is based on and claims the benefit of U.S. Provisional Patent Application Ser. No. 63/648,967 filed May 17, 2024, the content of which application is hereby incorporated by reference in its entirety.

### BACKGROUND

A field device is a device that is coupleable to a process, such as a manufacturing or refining process, to support the process by providing one or more functions of measuring and controlling parameters associated with the process. A field device is so named due to its ability to be mounted in the field. “Field” is generally an external area in a process installation that may be subject to climatological extremes, vibration, changes in humidity, electromagnetic or radiofrequency interference, or other environmental challenges. Thus, the robust physical package of such a field device provides it with the ability to operate in the “field” for extended periods (such as years) at a time.

Field devices such as process variable transmitters, are used in the process control industry to remotely sense a process variable. Field devices such as actuators are used by the process control industry to remotely control physical parameters of a process, such as flow rate, temperature, et cetera. The process variable may be transmitted to a control room from a field device such as a process variable transmitter for providing information about the process to a controller. The controller may then transmit control information to a field device such as an actuator to modify a parameter of the process. For example, information related to pressure of a process fluid may be transmitted to a control room and used to control a process such as oil refining.

Modern field devices (such as process pressure transmitters, process temperature transmitters, process flow transmitters, and process level transmitters) typically include highly sophisticated hardware and firmware within the field device to execute a vast amount of complex measurement and communication routines. Additionally, such devices may also incorporate diagnostic functions into on-board electronics to determine sensor and/or process measurement status for the purpose of determining confidence in the reported measurement. Diagnosing measurement issues (such as plugged impulse lines or sensor drift) and predicting potential sensor life is an important function of modern field devices.

Typically, these complex features and capabilities are only enabled and configured in the factory without the ability to activate, configure, or upgrade them in the field. Field devices are often deployed in extreme environments including hazardous areas where flammable and combustible materials may be present. This can render the field devices difficult to physically access. While there are inherent benefits to having such rich, complex functionality contained within the field device, the ability to upgrade or update the functionality is constrained by design cycle time and physical limitations within the users' operating environments. Field devices that are to be located in a hazardous environment must generally be constructed to be explosion protected using recognized techniques such as “intrinsic safety”.

An intrinsically safe field device prevents ignition of flammable gases by limiting the amount of energy present in the electronics and by ensuring that electronic components are spaced far enough apart to prevent arcing in the event of an electrical fault. The heat generated by electronic components is also controlled.

Legacy field communication protocols, such as HART® and FOUNDATION™ Fieldbus provide limited power and data bandwidth that can sometimes make it challenging to incorporate advanced functionality and to update field device firmware. Many digital field devices filter and process raw measurement data into characterized output values. The processing reduces the amount of data that needs to be communicated but can sometimes hide important features of the raw data that could be useful for instrument and process analytics.

### SUMMARY

A system for creating a virtual field device is provided. The system includes a processor having memory that when executed causes the processor to provide a sensor selection user interface element configured to receive user selection of at least one process sensor providing high-speed, unfiltered measurement data. The processor also provides a processing selection user interface element configured to receive user selection of at least one processing action to perform on the high-speed, unfiltered measurement data to generate a process output. The processor also provides an output selection user interface element configured to receive user selection of at least one remote device to which the process output is communicated. A computer-implemented method of creating a virtual field device is also provided.

### BRIEF DESCRIPTION OF THE DRAWINGS

FIG. 1 is a diagrammatic view of a process monitoring and control system using a virtual measurement and analytics platform in accordance with one embodiment.

FIG. 2 is a diagrammatic view of one example of a field device having or coupled to a process variable sensor in accordance with an embodiment described herein.

FIG. 3 is a diagrammatic view of one example of a field device having or coupled to an actuator in accordance with an embodiment of the present invention.

FIG. 4 is a diagrammatic view of one example of a field device having a display in accordance with an embodiment described herein.

FIG. 5 is a diagrammatic view of one example of a field device having a user interface in accordance with an embodiment described herein.

FIG. 6 is a diagrammatic view of a field device transmitting information over an Ethernet APL process communication segment in accordance with one embodiment.

FIG. 7 is a diagrammatic view of a process monitoring and control system in accordance with one embodiment.

FIG. 8 is a flow diagram of a method of creating a virtual field device in accordance with an embodiment of the present invention.

FIG. 9 is a flow diagram of a method of updating or modifying a virtual field device in accordance with an embodiment of the present invention.

FIG. 10 is a flow diagram of a method of creating a virtual field device with time synchronization of raw process data in accordance with an embodiment of the present invention.

FIG. 11 is a diagrammatic view of a remote server architecture in which embodiments of the present invention are particularly useful.

FIG. 12 is a block diagram of a mobile device which can be used in accordance with embodiments of the present invention.

FIG. 13 is a block diagram of a general-purpose computing system that can be used with embodiments of the present invention.

### DETAILED DESCRIPTION OF ILLUSTRATIVE EMBODIMENTS

With the recent advancements in high-speed digital process communication protocols, it is now possible to move heavy computational processing from the field device to an edge device or potentially into the cloud. One such high speed digital process communication protocol is known as Ethernet APL or similar high-speed communication protocol and provides higher power and bandwidths than previous process communication protocols. As used herein, such a similar high-speed communication protocol includes any protocol now known or later developed that provides at least bandwidth and power capabilities of Ethernet APL. This enables new advanced capabilities including low-latency communication of unfiltered process data, raw sensor data, and/or other diagnostic information.

While process control field devices typically use specialized communication hardware and protocols, it is well known to use a general-purpose IP or other packet-based communication protocol to perform communications between certain other devices within a process plant. For example, it is common to use a packet-based or general-purpose IP protocol on an Ethernet bus that communicatively connects one or more distributed process controllers to one or more user interfaces, databases (e.g., configuration databases and historian databases), servers, et cetera within a back-end plant environment. As such, Ethernet, which is a physical layer and partly a data link layer, is an important communication platform for automation systems as Ethernet enables flexibility, scalability, and performance in a way not seen before in automation. To help support the adoption of Ethernet in automation, an Advanced Physical Layer (APL) specification is being designed to support the connection of field devices in remote and hazardous locations. Behind APL is the IEEE P802.3cg project which is focused on the development of enhancements to the existing IEEE 802.3 Ethernet standard (IEEE 802.3) for Ethernet via twisted-pair wiring (10BASE-T1L). This development is significant because there is a long list of automation protocols developed for various purposes that can run on top of an Ethernet physical layer. One commercially-available APL physical layer module is sold by Texas Instruments of Dallas, Texas, under the trade designation DP83TD510E Ultra Low Power 802.3cg 10Base-T1L 10M Single Pair Ethernet PHY.

Using current high-speed process communication protocols, such as Ethernet APL, raw measurement data along with low level diagnostics information may be transmitted from one or more simplified and/or low-cost sensor modules to a virtual measurement and/or analytics platform with outputs being provided to a typical digital control or process monitoring and optimization system.

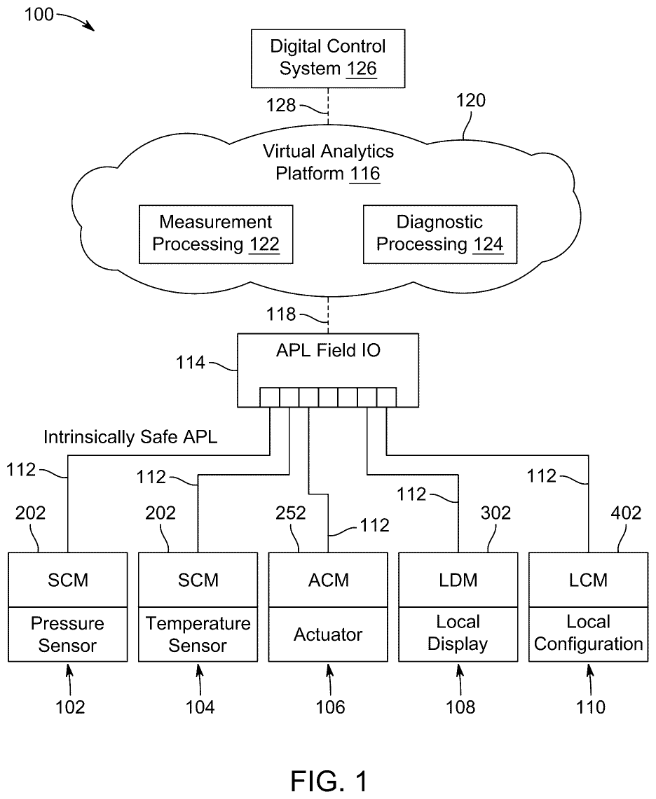

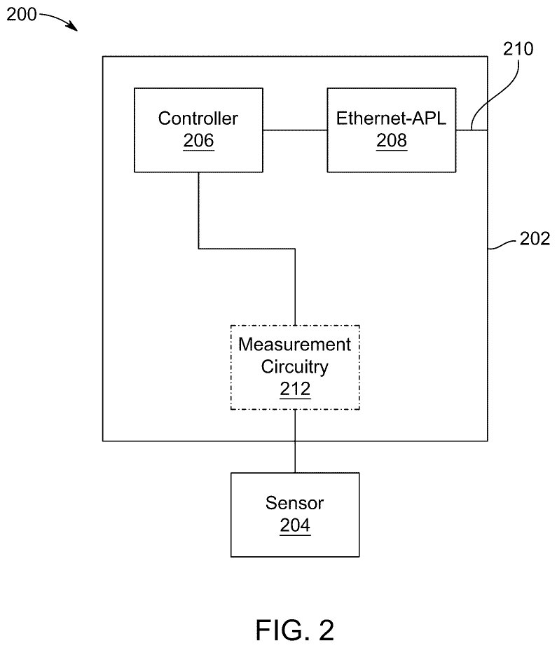

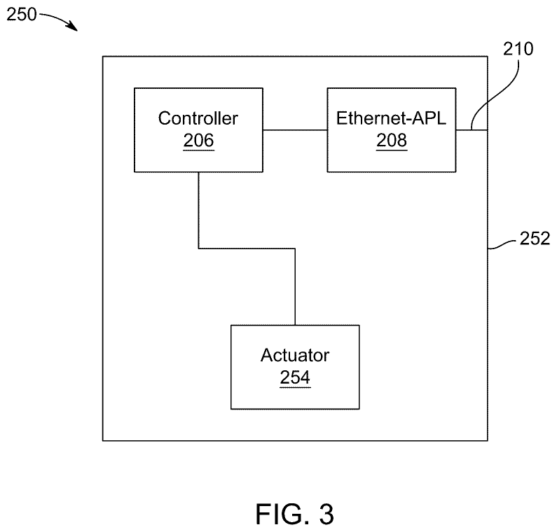

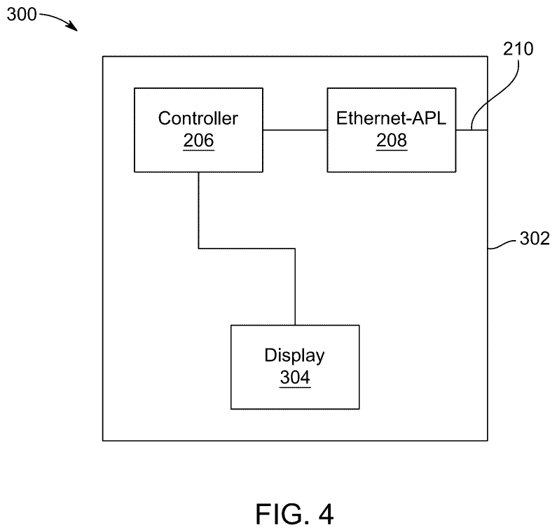

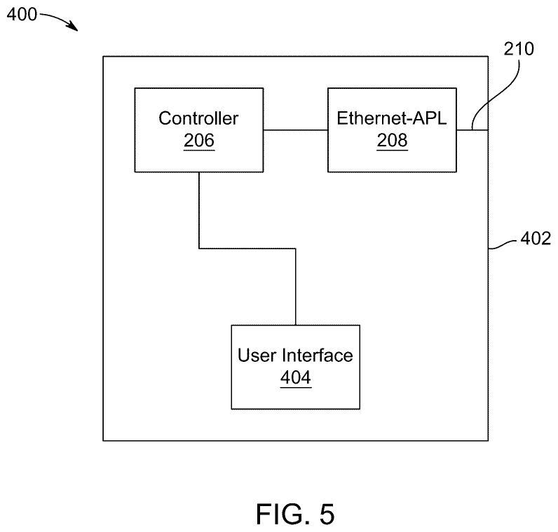

FIG. 1 is a diagrammatic view of a process monitoring and control system using a virtual measurement and/or analytics platform in accordance with one embodiment. System 100 includes a plurality of low-level field devices 102, 104, 106, 108, and 110 coupled to an Ethernet APL Field I/O module 114 via intrinsically-safe Ethernet APL links 112. Low-level sensor field devices 102 and 104 each include a sensor of some sort that couples to a sensor communication module 202, which will be described in greater detail with respect to FIG. 2. Low-level actuator field device includes an actuator of some sort, such as a valve positioner, in combination with an actuator control module 252 which will be described in greater detail with respect to FIG. 3. Additionally, low-level local display 108 includes a display in combination with a local display module 302, which will be described in greater detail with respect to FIG. 4. Finally, low-level local configuration field device 110 includes a local configuration interface (user interface, communication interface, or both) in combination with a local configuration module 402, which will be described in greater detail with respect to FIG. 5.

Module 114 is communicatively coupled to virtual analytics platform 116 via communication link 118, which may take any suitable form including a wired connection such as Ethernet or a wireless connection such as a Wi-Fi communication protocol, cellular communication protocol or satellite communication protocol. Suitable examples of cellular communication protocols include, without limitation, GPRS, UMTS, CDMA2000, LTE, LTE-M, NB-IoT, WiMax, 5G NR, and other protocols now used or later developed.

Platform 116 is illustrated within cloud 120 indicating that measurement processing 122 and/or diagnostic processing 124 occur in the cloud (i.e., on one or more computing devices remote from module 114 and field devices 102, 104, 106, 108, and 110). As can be seen, digital control system 126 is communicatively coupled to platform 116 via link 128. Digital control system 126 receives process variable measurements and/or diagnostic information and executes one or more process control functions based on the process variable measurements and/or diagnostic information. Digital control system 126 is configured to generate one or more control signals based on pre-defined control functions and/or user inputs to control the process. Additionally, it is expressly contemplated that digital control system 126 may, in some embodiments, be simply used to monitor the process.

The use of virtual analytics platform 116 deployed on one or more generic, high performance computing devices (including in cloud 120) provides a number of benefits. Diagnostics and analytics complexity is no longer limited by power limitations and/or CPU capacity of a field device. Diagnostics can also be enabled, disabled, licensed, upgraded, updated, and downgraded, as desired, without manipulating sensors in the field connected to the process. For example, diagnostics and analytics can be enabled or disabled depending on immediate user need, such as troubleshooting a process anomaly. In another example, a user may simply want to enable more complex process variable data processing for a defined period of time and then subsequently disable enhanced processing or analytics.

Embodiments described herein also enable high-speed sensor measurements to be available for use in multi-sensor and/or complex process analytics and modelling. For example, a process fluid pressure measurement and a process fluid temperature measurement can be obtained in two different devices, but the sensor data can be precisely related to time (e.g., via a time stamp) such that the values from the different sensors can be combined or otherwise analyzed in virtual analytics platform 120 as having the same effective time. In another example, a flow velocity measurement, a pressure measurement and a temperature measurement can each be precisely associated with time (e.g., via a time stamp) such that values from two different locations along the flow can be precisely correlated using distance along the flow conduit, flow velocity, and time stamp. In still another example, vibration or acoustic sensors located at different locations throughout a process installation can associate their detection of acoustic or vibration signals precisely with time (e.g., via a time stamp) in order to geolocate a source of the signal and/or facilitate root cause diagnostics or troubleshooting.

Additionally, time synchronization of measurement acquisition coupled with high-speed communication enables new multi-sensor fusion applications. Real-time communication of time-tagged raw sensor data (e.g., unfiltered and/or uncharacterized) allows for the application of modern artificial intelligence and machine learning techniques to generate advanced process analytics and a variety of advanced diagnostics (sensor diagnostics, process diagnostics, validation of measurement values, et cetera). This is because the resources required for modern artificial intelligence and/or machine learning generally exceeded the available resources of field devices. Thus, time-tagged (e.g., via time stamps) raw sensor data can be communicated to virtual analytics platform 120, which is not resource-constrained, and thus allows a full complement of AI and machine learning functions and abilities, which may even change and/or improve over time.

Embodiments described herein also allow for the licensing of enhanced measurement performance as well as advanced analytic and diagnostic functions. For example, licensed advanced analytics may apply complex statistical and/or machine learning to the raw sensor feed(s) to provide additional insight into the process. Such processing could be based upon storing a large number of raw sensor values, where the number of sensor values exceeds the storage capacity of a local field device. This added functionality can be selectively enabled/disabled at the cloud processing level without affecting the field devices.

Embodiments also allow for high fidelity sensor digital twin applications (i.e., a virtual field device that receives raw sensor information and provides a process variable output that should be identical to that of the local field device). In a similar embodiment, a sophisticated virtual instrument can be defined based upon receiving combinations of raw sensor data from two or more sensors. These may be sensors of the same type (e.g., multiple temperature sensors) or sensors of different types (flow velocity, pressure, and temperature). Additionally, embodiments described herein also allow for full context protocol translation.

FIG. 2 is a diagrammatic view of one example of a field device having or coupled to a process variable sensor in accordance with an embodiment described herein. Field device 200 includes a sensor communication module 202 coupled to a process variable sensor 204. Process variable sensor 204 may be any suitable process variable sensor having an electrical characteristic that varies with a process variable of interest (e.g., pressure, temperature, level, pH, conductivity, flow, turbidity, position, motor current, motor back emf, and vibration). Sensor communication module 202, in one embodiment, includes minimal components and capabilities in order to perform the required functions (e.g., measure the sensor characteristic and communicate the measurement using Ethernet APL). As shown in FIG. 2, sensor communication module 202 includes a controller 206 coupled to Ethernet APL circuitry 208, which is configured to couple to a remote device via Ethernet APL port 210. FIG. 2 also illustrates controller 206 operably coupled to sensor 204 via optional measurement circuitry 212. Measurement circuitry 212 may include a suitable analog-to-digital converter that is able to provide a digital indication of the electrical characteristic of sensor 204 to controller 206. However, in embodiments where controller 206 is a microcontroller that already includes suitable measurement circuitry (such as analog-to-digital measurements), measurement circuitry 212 may be omitted. One such microcontroller is available from Microchip Technology, Incorporated of Chandler, Arizona under the trade designation ATtiny series.

Ethernet APL communication circuitry 208 is coupled to controller 206 and allows controller 206 to communicate in accordance with Ethernet APL process communication. The link between controller 206 and Ethernet APL circuitry 208 is preferably a high-speed link that is faster than or at least a significant fraction of the bandwidth provided by Ethernet APL communication circuitry 208. Examples of the high-speed link can include SPI, 12C, and UART. Additionally, it is expressly contemplated that controller 206 and Ethernet APL circuitry may be embodied in the same device, such as an application specific integrated circuit (ASIC). In one example, Ethernet APL circuitry is available from Analog Devices of Wilmington, Massachusetts under the trade designation ADIN 1100.

FIG. 3 is a diagrammatic view of one example of a field device having or coupled to an actuator in accordance with an embodiment of the present invention. Field device 250 bears some similarity to field device 200 and like components are numbered similarly. Field device 250 includes actuator control module 252 coupled to actuator 254. Actuator 254 may be any suitable process actuator that generates a physical change on the process based on a received signal, such process actuators include, without limitation, valve controllers, heaters, and motor controllers. As shown, actuator control module 252 may include a controller 206 and Ethernet APL 208 circuitry, which may be the same as the controller and Ethernet APL circuitry described with respect to FIG. 2 or they may be different. Field device 250 is configured to be mounted in the field and generate a physical process change based on information that is received over an Ethernet APL link or segment using Ethernet APL communication circuitry 208.

FIG. 4 is a diagrammatic view of one example of a field device having a display in accordance with an embodiment described herein. Field device 300 bears some similarity to field device 200 and like components are numbered similarly. Field device 300 includes local display module 302 that has or is coupled to display 304. Display 304 can be any suitable display including, without limitation, an LCD display, an LED display, a vacuum fluorescent display (VFD), an OLED display, e-ink display, or any other suitable type of display. As shown, local display module 302 may include a controller 206 and Ethernet APL 208 circuitry, which may be the same as the controller and Ethernet APL circuitry described with respect to FIG. 2 or they may be different. Field device 300 is configured to be mounted in the field and display information that is received over an Ethernet APL link or segment using Ethernet APL communication circuitry 208.

FIG. 5 is a diagrammatic view of one example of a field device having a user interface in accordance with an embodiment described herein. Field device 400 bears some similarity to field devices 200 and 300 and like components are numbered similarly. Field device 400 includes local configuration module 402. Field device 400 includes user interface 404 that may include a display, such as display 304 shown in FIG. 4, as well as one or more user input devices. User input devices include, without limitation, buttons, knobs, joysticks, keyboards, microphones, cameras, touchpads, switches, et cetera. A user interface 404 may also include an RF user interface, such as a Bluetooth Low-Energy (Ble) interface of an RFID interface. As shown, local configuration module 402 may include a controller 206 and Ethernet APL circuitry 208, which may be the same as the controller and Ethernet APL circuitry described with respect to FIG. 2 or they may be different. Field device 400 is configured to be mounted in the field and allow a user thereof to configure one or more field devices, both virtual and non-virtual, using information that is transmitted/received over an Ethernet APL link or segment using Ethernet APL communication circuitry 208. Field deployable user interfaces such as field device 400 connected to the virtual measurement and analytics platform 116 using high-speed communication protocols such as Ethernet APL 112 to provide field accessibility of measurement, diagnostics, and analytical data provides significant advantages to users. Field deployable configuration interfaces such as field device 400 connect to the virtual measurement and analytics platform 116 using high-speed communication protocols such as Ethernet APL 112 to provide an efficient way to field configure and calibrate the virtual measurement and analytic applications.

Embodiments described herein can be used to independently validate calculations being made in embedded field measurement instruments. This is useful, for example, to provide a measure of fault tolerance for critical applications requiring high accuracy and/or high reliability.

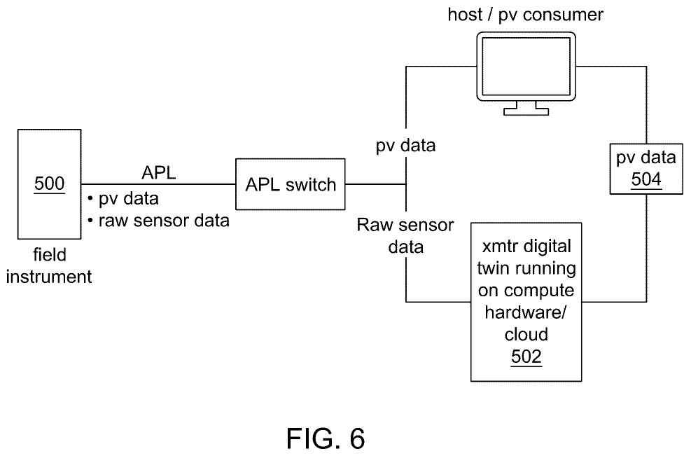

FIG. 6 is a diagrammatic view of a field device transmitting information over an Ethernet APL process communication segment in accordance with one embodiment. As shown in FIG. 6, field device 500 can send both process variable (PV) data and uncharacterized, raw sensor data using a high speed, high bandwidth digital field protocol such as Ethernet APL. Preferably, all data is precisely time-stamped to allow temporal correlation by downstream users. The raw sensor data is routed to a generic compute resource, such as an edge apparatus, on-premises server, the cloud, or virtual digital twin 502. The raw sensor data is then characterized using the same or similar calculations that are present within the processor of field device 500 to independently produce the process variable value in digital twin 502. The PV data generated by field device 500 as well as the PV data 504 generated from the raw sensor data in generic compute hardware can then be polled by or published to a process variable consumer system such as a logic controller, control system, or asset monitoring system. The host system can then validate each piece of data by comparing the two independently derived values. If the values match, the data is validated. If the PV data does not match within a predetermined margin, the data is marked as suspect and an alert is generated to alert operators of a potential issue.

In one example, field instrument 500 may be a Coriolis flow meter coupled to a host system that receives high-accuracy, time synchronized process measurement data from both the Coriolis flow meter and its digital twin. This host system may compare the two process measurement values to determine the accuracy and health of the field measurement data. For example, the flow value published directly from a Coriolis flow meter may be compared to the flow value calculated and published by its digital twin. If the values agree within acceptable tolerance, the accuracy of the measurement is confirmed. If the values do not agree, the values can be indicated as suspect, and a diagnostic notification can be raised to allow the system and its operators to respond appropriately.

As set forth above, embodiments incudes a digital ‘twin’ of the process measurement instrument, excluding the sensor itself, running on edge, server, or cloud-based computing hardware. Transformation of raw sensor data into high accuracy process measurement values is done on this higher-level computing hardware. For example, linearity and temperature effect information collected during production testing of a Coriolis sensor could be used to transform raw sensor data into corrected flow measurement values as well as to extract various health and diagnostic information.

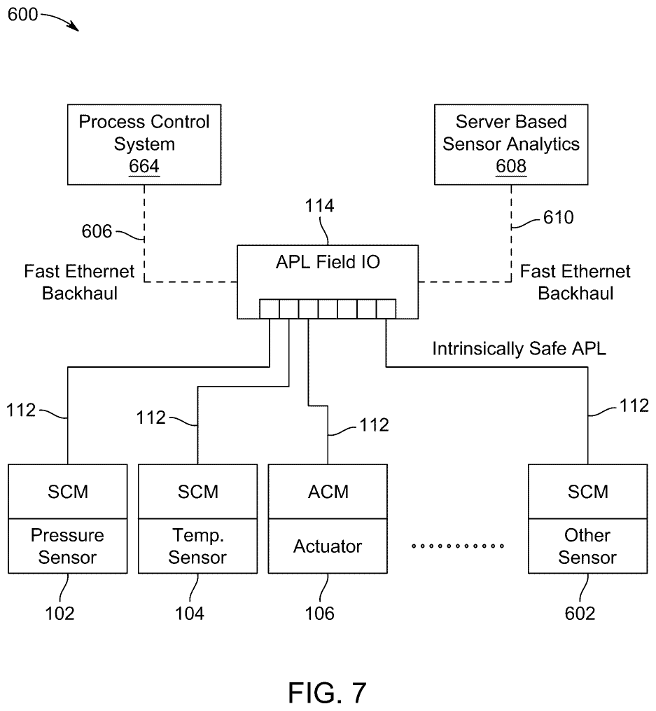

FIG. 7 is a diagrammatic view of a process monitoring and control system in accordance with one embodiment. System 600 bears some similarities to system 100 (shown in FIG. 1) and like components are numbered similarly. As shown, system 600 includes a number of field devices, such as pressure transmitter 102, temperature transmitter 104, level transmitter 106, and other transmitter 602 (which denotes any sort of sensor and sensing electronics). Transmitters 102, 104, 106, and 602 are all configured to communicate in accordance with a high-speed process communication protocol such as Ethernet APL. Field devices 102, 104, 106, and 602 are each coupled to Ethernet APL Field I/O module 114 via an intrinsically safe Ethernet APL link or segment. Module 114 is coupled to process control system 604 via fast ethernet backhaul link 606. This allows process control system 604 to receive high-speed, high bandwidth sensor values from field devices 102, 104, 106, 602, calculate process variables based on such sensor values, and provide control signals to control the process. As can be seen, module 114 is also coupled to server-based sensor analytics device 608 via fast ethernet backhaul link 610. Sensor analytics device 608 receives raw, unfiltered sensor data and provides higher level analytics on such data to generate diagnostic data, complex process modelling or prediction, sensor fusion, custom process visualizations, et cetera.

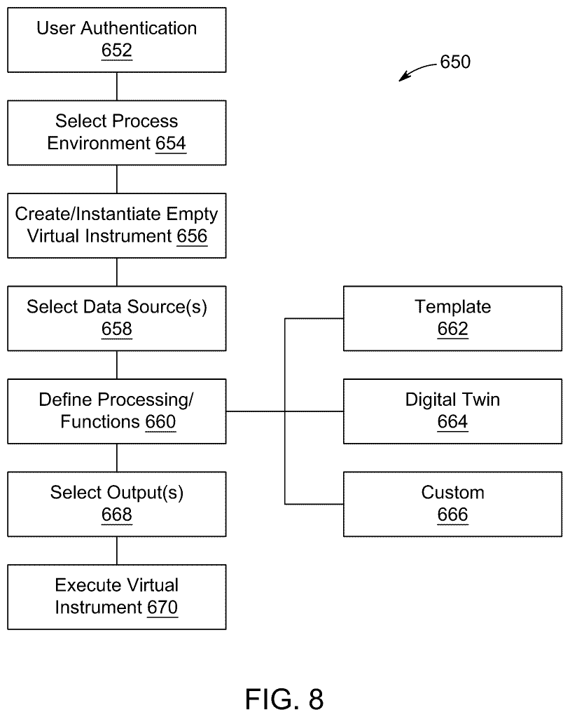

FIG. 8 is a flow diagram of a method of creating a virtual field device in accordance with an embodiment of the present invention. Method 650 begins at block 652 where a user authenticates to digital control system 126 or to virtual analytics platform 116. The user may use any suitable computing device for method 650 including a desktop computer, laptop computer, tablet computer or smartphone. Once authenticated, the user will select the process environment (e.g., plant, location, et cetera) in which the new virtual field device will operate, as indicated at block 654. Then, at block 656, the user actuates a user interface element to create or otherwise instantiate an empty or new virtual instrument/field device. Next, at block 658, the user selects one or more data sources for the new virtual field device. Examples of data sources include pressure sensor 102 (shown in FIG. 1), which transmits raw sensor data over an intrinsically-safe APL link 112; temperature sensor 104 (also shown in FIG. 1); as well as conventional field devices, such as a process temperature transmitter or a process fluid flow meter.

At block 660, the user defines how the data from the selected data sources is processed. The user may select a pre-defined template 662, which may be provided for frequently-used field devices, such as a temperature transmitter or pressure transmitter. The selected processing can include any suitable mathematical functions, statistical functions, algorithmic functions, machine learning or artificial intelligence functions as may be desired to provide useful output information. Additionally, as shown in FIG. 8, the user may select a digital twin as indicated by block 664. When selected, the virtual field device will employ the same processing as performed by the selected data source (such as a process variable pressure transmitter) using raw sensor data. In this way, the transmitter digital twin should provide the same process variable output as the selected data source (shown in FIG. 6). When both agree, enhanced process data fidelity is provided. As shown in FIG. 8, defining processing/functions at block 660 can also include any suitable custom functions/processing 666 as well as various combinations of processing/functions.

At block 668, the user selects one or more outputs for the virtual field device. A process variable output can be provided, for example, to digital control system 126 (shown in FIG. 1) and/or to a local display, such as local display 108 (shown in FIG. 1). Once the output(s) has been specified, control passes to block 670 where the user executes the virtual field device. When this occurs, the virtual field device will begin receiving data from the selected data sources and processing the received data as configured during block 660 to provide one or more outputs as specified at block 668.

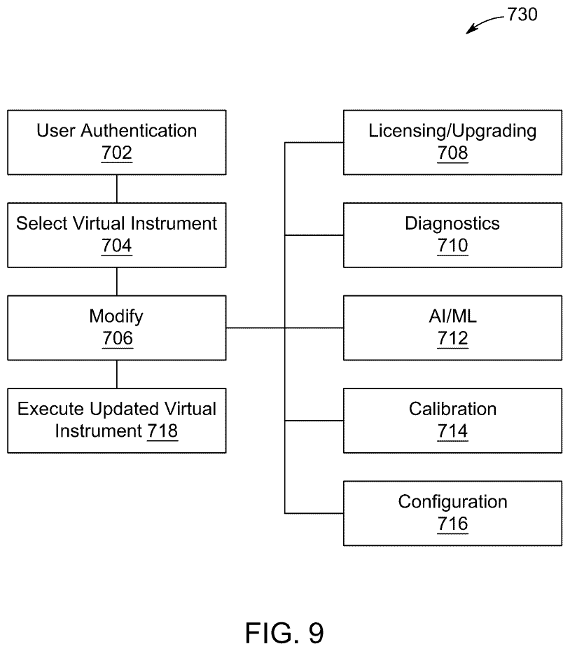

FIG. 9 is a flow diagram of a method of updating or modifying a virtual field device in accordance with an embodiment of the present invention. Method 700 begins at block 702 where a user authenticates to digital control system 126 or to virtual analytics platform 116. The user may use any suitable computing device for method 700 including a desktop computer, laptop computer, tablet computer or smartphone. Once authenticated, the user selects a virtual field device to modify, as indicated at block 704. When the user selects a virtual field device, control passes to block 706 where the user can apply one or more modifications to the selected field device.

Modifications 706 can include licensing/upgrading 708; diagnostics 710; Artificial Intelligence/Machine Learning 712; calibration 714; and configuration 716. The licensing/upgrading function 708 can include an e-commerce functionality to allow the user to purchase a licensable function or feature (such a bulk storage of raw sensor data for a selected period of time). In another example, the licensable or upgradeable functionality may include sensor performance and correction algorithms. For example, temperature products could provide noise filtering to improve effective resolution through smart filtering and analog to digital adjustments.

Diagnostics modification 710 may also include an e-commerce functionality to allow the user to purchase or otherwise obtain selected diagnostic features relative to the virtual field device for a defined amount of time. Such diagnostic features may help perform process troubleshooting, field device troubleshooting, or both.

Artificial intelligence/Machine Learning upgrade 712 may also include an e-commerce functionality to allow the user to purchase or otherwise obtain selected artificial intelligence or machine learning functionality. Licensable and upgradeable machine learning models that can be trained for process optimization, machinery health, energy efficiency, and other valuable tasks and may be uploaded from the factory to the virtual analytics platform to be selectively enabled by the user when needed or desired. Accordingly, embodiments herein provide the use of artificial intelligence and machine learning techniques applied to low-level, unfiltered sensor data delivered to generic, high-performance computing platforms using high-speed field communication protocols such as Ethernet APL from one or a plurality of field sensors.

At blocks 714, and 716, the user can modify calibration and configuration information for the virtual field device, respectively. Such calibration and configuration may also leverage field deployable configuration interfaces, such as local configuration device 110 (shown in FIG. 1) connected to the virtual measurement and analytics platform 116 using high-speed communication protocols such as Ethernet APL to provide a way to field configure and calibrate the measurement and analytic applications. However, in some embodiments, functionality 714 and 716 simply provides an easily upgradeable sensor calibration and configuration from the factory into the virtual measurement and analytics platform. Once the modifications to the virtual field device have been completed at block 706, control passes to block 718 where the modified virtual field device is executed.

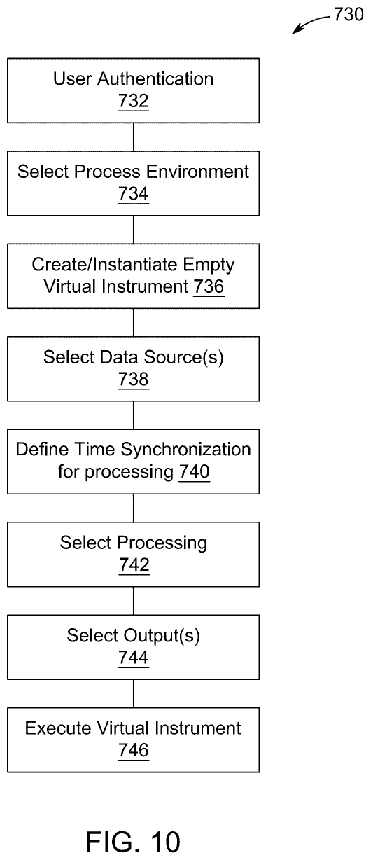

FIG. 10 is a flow diagram of a method of creating a virtual field device with time synchronization of raw process data in accordance with an embodiment of the present invention. Method 730 begins at block 732 where a user authenticates to digital control system 126 or to virtual analytics platform 116. The user may use any suitable computing device for method 730 including a desktop computer, laptop computer, tablet computer or smartphone. Once authenticated, the user will select the process environment (e.g., plant, location, et cetera) in which the new virtual field device will operate, as indicated at block 734. Next, at block 736, the user creates an empty virtual instrument. Then, at block 738, the user selects one or more data sources for the new virtual field instrument. At block 740, the user defines time synchronization for the various time sources. For example, the user may specify that the data from multiple data sources be obtained within x milliseconds or y microseconds. Further, the user may specify that data from one source should lag data from another source by x milliseconds, for example, when the physical locations are separated by a flow conduit. Finally, the time lag may also be defined as a function of flow velocity such that data from two separate locations can be correlated based on process fluid flow.

Once the time synchronization is set at block 740, the user can select any suitable processing at block 742 and then indicate where the output of the virtual field device should be sent at block 744. Finally, once the output(s) has been specified, control passes to block 746 where the virtual field device is executed.

Sensor communication modules are preferably provided with minimal functionality required to generate, package and transport raw measurement data, low-level diagnostics, and/or basic process measurement values via modern, high-speed industrial field communication protocols such as Ethernet APL to higher level measurement and analytics platform deployed on generic, high-power computing hardware and/or to the cloud for processing. This helps drive the cost of deployment down, while still allowing rich functionality.

Embodiments described herein generally employ a high-speed, low latency industrial field communication protocol, such as Ethernet APL, to partition advanced measurement and diagnostic functions, deploying some of these functions in generic, high-performance computing platforms. This allows for easy updating of advanced software functions without replacing field hardware. The approach also allows for advanced analytics based on raw, unfiltered sensor data processed through cutting edge artificial intelligence and machine learning techniques that may require resources not available in field instruments or devices and that must be retrained and revised frequently. The approach also allows for the licensing of measurement, diagnostic, and analytical features including virtual field devices made possible through time synchronized measurement acquisition from multiple field devices. This may also simplify or even eliminate hazardous location approvals. Additionally, using techniques described herein, power budget constraints are eliminated and the design process is simplified.

The present discussion has mentioned processors and servers. In one embodiment, the processors and servers include computer processors with associated memory and timing circuitry, not separately shown. They are functional parts of the systems or devices to which they belong and are activated by and facilitate the functionality of the other components or items in those systems.

Also, a number of user interface displays have been discussed. They can take a wide variety of different forms and can have a wide variety of different user actuatable input mechanisms disposed thereon. For instance, the user actuatable input mechanisms can be text boxes, check boxes, icons, links, drop-down menus, search boxes, etc. They can also be actuated in a wide variety of different ways. For instance, they can be actuated using a point and click device (such as a track ball or mouse). They can be actuated using hardware buttons, switches, a joystick or keyboard, thumb switches or thumb pads, etc. They can also be actuated using a virtual keyboard or other virtual actuators. In addition, where the screen on which they are displayed is a touch sensitive screen, they can be actuated using touch gestures. Also, where the device that displays them has speech recognition components, they can be actuated using speech commands.

A number of data stores have also been discussed. It will be noted they can each be broken into multiple data stores. All can be local to the systems accessing them, all can be remote, or some can be local while others are remote. All of these configurations are contemplated herein.

Also, the figures show a number of blocks with functionality ascribed to each block. It will be noted that fewer blocks can be used so the functionality is performed by fewer components. Also, more blocks can be used with the functionality distributed among more components.

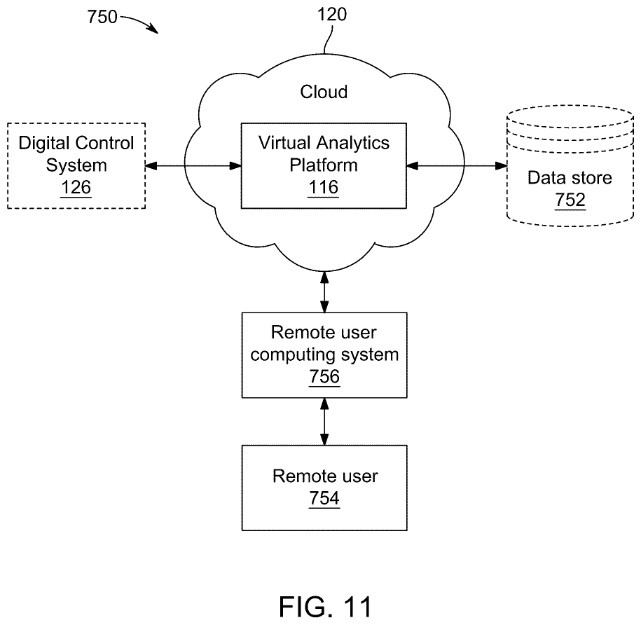

FIG. 11 is a diagrammatic view of a remote server architecture in which embodiments of the present invention are particularly useful. In an example, remote server architecture 750 can provide computation, software, data access, and storage services that do not require end-user knowledge of the physical location or configuration of the system that delivers the services. A remote user 754 uses a remote user computing system 756 to access virtual analytics platform 116 in cloud 120. In various embodiments, remote servers can deliver the services over a wide area network, such as the internet, using appropriate protocols. For instance, remote servers can deliver applications over a wide area network and they can be accessed through a web browser or any other computing component. Software or components shown in FIG. 1 as well as the corresponding data can be stored on servers at a remote location. The computing resources in a remote server environment can be consolidated at a remote data center location or they can be dispersed. Remote server infrastructures can deliver services through shared data centers, even though they appear as a single point of access for the user. Thus, the components and functions described herein can be provided from a remote server at a remote location using a remote server architecture. Alternatively, they can be provided from a conventional server, or they can be installed on client devices directly, or in other ways.

In the example shown in FIG. 11, some items are similar to those shown in FIG. 1 and they are similarly numbered. Virtual analytics platform 116 is shown located at a remote server location in cloud 120, while data store 752 is located at a different location remote from virtual analytics platform 116. Accordingly, FIG. 11 shows that some elements of the remote server architecture may be located in cloud 120 while others, such as data store 752, need not be. Regardless of where they are located, they can be accessed by users through a network (either a wide area network or a local area network), they can be hosted at a remote site by a service, or they can be provided as a service, or accessed by a connection service that resides in a remote location. Also, the data can be stored in substantially any location and intermittently accessed by, or forwarded to, interested parties. All of these architectures are contemplated herein.

It will also be noted that the elements of FIG. 1, or portions of them, can be disposed on a wide variety of different devices. Some of those devices include servers, desktop computers, laptop computers, tablet computers, or other mobile devices, and smartphones.

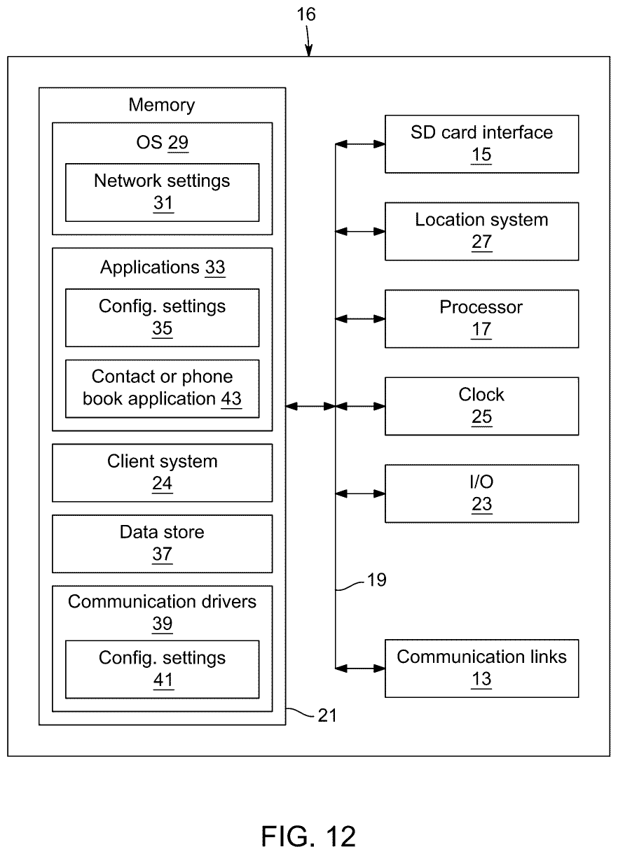

FIG. 12 is a simplified block diagram of one illustrative example of a handheld or mobile computing device that can be used as a user's or client's handheld device 16, in which the present system (or parts of it) can be deployed. For instance, a mobile device can be deployed as remote user computing system 756 (shown in FIG. 11) for use in generating, processing, or displaying the information discussed herein. FIG. 12 provides a general block diagram of the components of a client device 16 that can run some components shown in FIG. 1, that interacts with them, or both. In device 16, a communications link 13 is provided that allows the handheld device to communicate with other computing devices and in some examples provide a channel for receiving information automatically, such as by scanning. Examples of communications link 13 include allowing communication though one or more communication protocols, such as wireless services used to provide cellular access to a network, as well as protocols that provide local wireless connections to networks.

In other examples, applications and/or data can be received on a removable Secure Digital (SD) card that is connected to an interface 15. Interface 15 and communication links 13 communicate with a processor 17 (which can also embody processors or servers from previous FIGS.) along a bus 19 that is also connected to memory 21 and input/output (I/O) components 23, as well as clock 25 and location system 27.

I/O components 23, in one embodiment, are provided to facilitate input and output operations. I/O components 23 for various embodiments of the device 16 can include input components such as buttons, touch sensors, optical sensors, microphones, touch screens, proximity sensors, accelerometers, orientation sensors and output components such as a display device, a speaker, and or a printer port. Other I/O components 23 can be used as well.

Clock 25 illustratively comprises a real time clock component that outputs a time and date. It can also, illustratively, provide timing functions for processor 17.

Location system 27 illustratively includes a component that outputs a current geographical location of device 16. This can include, for instance, a global positioning system (GPS) receiver, a LORAN system, a dead reckoning system, a cellular triangulation system, or other positioning system.

Memory 21 stores operating system 29, network settings 31, applications 33, application configuration settings 35, data store 37, communication drivers 39, and communication configuration settings 41. Memory 21 can include all types of tangible volatile and non-volatile computer-readable memory devices. It can also include computer storage media (described below). Memory 21 stores computer readable instructions that, when executed by processor 17, cause the processor to perform computer-implemented steps or functions according to the instructions. Processor 17 can be activated by other components to facilitate their functionality as well.

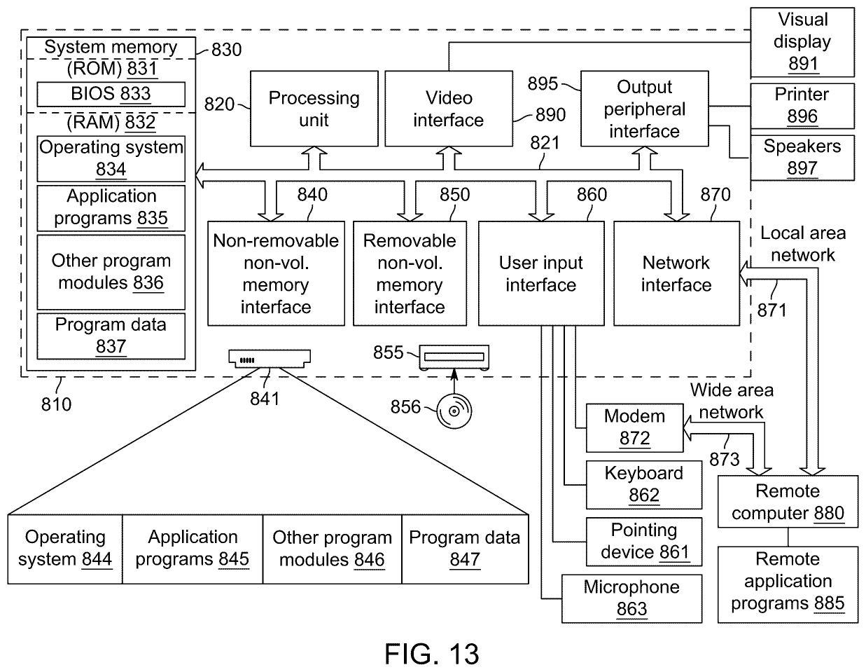

FIG. 13 is one example of a computing environment in which elements of FIG. 1, or parts of it, (for example) can be deployed. With reference to FIG. 13, an example system for implementing some embodiments includes a general-purpose computing device in the form of a computer 810. Components of computer 810 may include, but are not limited to, a processing unit 820 (which can comprise processors or servers from previous FIGS.), a system memory 830, and a system bus 821 that couples various system components including the system memory to the processing unit 820. The system bus 821 may be any of several types of bus structures including a memory bus or memory controller, a peripheral bus, and a local bus using any of a variety of bus architectures.

Computer 810 typically includes a variety of computer readable media. Computer readable media can be any available media that can be accessed by computer 810 and includes both volatile and nonvolatile media, removable and non-removable media. By way of example, and not limitation, computer readable media may comprise computer storage media and communication media. Computer storage media is different from, and does not include, a modulated data signal or carrier wave. It includes hardware storage media including both volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by computer 810. Communication media may embody computer readable instructions, data structures, program modules or other data in a transport mechanism and includes any information delivery media. The term “modulated data signal” means a signal that has one or more of its characteristics set or changed in such a manner as to encode information in the signal.

The system memory 830 includes computer storage media in the form of volatile and/or nonvolatile memory such as read only memory (ROM) 831 and random access memory (RAM) 832. A basic input/output system 833 (BIOS), containing the basic routines that help to transfer information between elements within computer 810, such as during start-up, is typically stored in ROM 831. RAM 832 typically contains data and/or program modules that are immediately accessible to and/or presently being operated on by processing unit 820. By way of example, and not limitation, FIG. 13 illustrates operating system 834, application programs 835, other program modules 836, and program data 837.

The computer 810 may also include other removable/non-removable volatile/nonvolatile computer storage media. By way of example only, FIG. 13 illustrates a hard disk drive 841 that reads from or writes to non-removable, nonvolatile magnetic media, an optical disk drive 855, and nonvolatile optical disk 856. The hard disk drive 841 is typically connected to the system bus 821 through a non-removable memory interface such as interface 840, and optical disk drive 855 are typically connected to the system bus 821 by a removable memory interface, such as interface 850.

Alternatively, or in addition, the functionality described herein can be performed, at least in part, by one or more hardware logic components. For example, and without limitation, illustrative types of hardware logic components that can be used include Field-programmable Gate Arrays (FPGAs), Application-specific Integrated Circuits (e.g., ASICs), Application-specific Standard Products (e.g., ASSPs), System-on-a-chip systems (SOCs), Complex Programmable Logic Devices (CPLDs), etc.

The drives and their associated computer storage media discussed above and illustrated in FIG. 13, provide storage of computer readable instructions, data structures, program modules and other data for the computer 810. In FIG. 13, for example, hard disk drive 841 is illustrated as storing operating system 844, application programs 845, other program modules 846, and program data 847. Note that these components can either be the same as or different from operating system 834, application programs 835, other program modules 836, and program data 837.

A user may enter commands and information into the computer 810 through input devices such as a keyboard 862, a microphone 863, and a pointing device 861, such as a mouse, trackball or touch pad. Other input devices (not shown) may include a joystick, game pad, satellite dish, scanner, or the like. These and other input devices are often connected to the processing unit 820 through a user input interface 860 that is coupled to the system bus, but may be connected by other interface and bus structures. A visual display 891 or other type of display device is also connected to the system bus 821 via an interface, such as a video interface 890. In addition to the monitor, computers may also include other peripheral output devices such as speakers 897 and printer 896, which may be connected through an output peripheral interface 895.

The computer 810 is operated in a networked environment using logical connections (such as a local area network-LAN, or wide area network WAN) to one or more remote computers, such as a remote computer 880.

When used in a LAN networking environment, the computer 810 is connected to the LAN 871 through a network interface or adapter 870. When used in a WAN networking environment, the computer 810 typically includes a modem 872 or other means for establishing communications over the WAN 873, such as the Internet. In a networked environment, program modules may be stored in a remote memory storage device. FIG. 13 illustrates, for example, that remote application programs 885 can reside on remote computer 880.

It should also be noted that the different examples described herein can be combined in different ways. That is, parts of one or more examples can be combined with parts of one or more other examples. All of this is contemplated herein.

Although the present invention has been described with reference to preferred embodiments, workers skilled in the art will recognize that changes may be made in form and detail without departing from the spirit and scope of the invention.

What is claimed is:

1. A system for creating a virtual field device, the system comprising:
a processor having memory that when executed causes the processor to provide:
a sensor selection user interface element configured to receive user selection of at least one process sensor providing high-speed, unfiltered measurement data;
a processing selection user interface element configured to receive user selection of at least one processing action to perform on the high-speed, unfiltered measurement data to generate a process output; and
an output selection user interface element configured to receive user selection of at least one remote device to which the process output is communicated.

2. The system of claim 1, wherein the sensor selection user interface is configured to receive a user selection of a plurality of sensors, each of which provides high-speed, unfiltered measurement data.

3. The system of claim 2, wherein the at least two of the plurality of sensors are sensors of different types.

4. The system of claim 2, wherein the at least one remote device includes a digital control system.

5. The system of claim 2, wherein the output is provided with sufficient speed to enable real-time process control.

6. The system of claim 2, wherein the processing includes processing of high-speed, unfiltered measurement data from the plurality of sensors to generate the process output.

7. The system of claim 2, wherein the processor is configured to generate a time synchronization user interface element configured to receive user input defining time synchronization with respect to at least one of the plurality of selected process sensors.

8. The system of claim 1, wherein the high-speed, unfiltered measurement data is provided using Ethernet APL.

9. The system of claim 1, wherein the processing includes mathematical processing of the high-speed, unfiltered measurement data.

10. The system of claim 1, wherein the processing includes statistical processing of the high-speed, unfiltered measurement data.

11. The system of claim 1, wherein the processing includes algorithmic processing of the high-speed, unfiltered measurement data.

12. The system of claim 1, wherein the processing includes artificial intelligence processing of the high-speed, unfiltered measurement data.

13. The system of claim 1, wherein the processing selection user interface element is configured to display a plurality of templates for field devices.

14. The system of claim 1, wherein the processing selection user interface element is configured to allow the user to create a digital twin of the selected sensor.

15. A computer-implemented method of creating a virtual field device, the method comprising:
receiving user selection of at least one process sensor providing high-speed, unfiltered measurement data;
receiving user selection of at least one processing action to perform on the high-speed, unfiltered measurement data to generate a process output; and
receive user selection of at least one remote device to which the process output is communicated.

16. The computer-implemented method of claim 15, and further comprising authenticating to a virtual analytics platform prior to creating the virtual field device.

17. The computer-implemented method of claim 15, wherein user selection of at least one process sensor includes user selection of a plurality of process sensors.

18. The computer-implemented method of claim 17, wherein the plurality of process sensor are of the same type.

19. The computer-implemented method of claim 17, includes receiving user input defining time synchronization with respect to at least one of the plurality of selected process sensors.

20. The computer-implemented method of claim 15, wherein user selection of at least one processing action includes at least one processing action selected from the group consisting of mathematical processing, statistical processing, algorithmic processing, machine learning processing and artificial intelligence processing.

21. The computer-implemented method of claim 15, wherein user selection of at least one remote device includes selection of a digital control system.

22. The computer-implemented method of claim 15, wherein user selection of at least one remote device includes selection of a local display.
